(19) United States
(12) Patent Application Publication
(10) Pub. No.: US 2026/0227030 A1
(43) Pub. Date: Aug. 6, 2026

(54) METHOD FOR PRODUCING A POLAR-CAP REINFORCEMENT FOR A PRESSURE VESSEL, AND PRESSURE VESSEL HAVING POLAR-CAP REINFORCEMENT

(71) Applicant: Thomas BÄUMER, Hückelhoven (DE)

(72) Inventor: Thomas BÄUMER, Hückelhoven (DE)

(21) Appl. No.: 19/150,864

(22) PCT Filed: Feb. 2, 2024
(86) PCT No.: PCT/EP2024/052595

§ 371 Date: Jul. 24, 2025

(30) Foreign Application Priority Data
Feb. 3, 2023 (DE) 10 2023 102 709.3

(51) Int. Cl. F17C 1/06; B29C 53/56; B29C 53/60

(52) U.S. Cl. CPC F17C 1/06; B29C 53/562; B29C 53/60; F17C 2201/0109; F17C 2203/066; F17C 2203/0663

(57) ABSTRACT

A method for producing a polar-cap reinforcement for a fiber-reinforced pressure vessel is provided. The method includes: providing a shaping tool in the form of at least one curved, dome-shaped polar-cap region with a winding axis which extends along the longitudinal axis of the polar-cap region; and producing at least one polar-cap reinforcement on the shaping tool in that a preimpregnated fiber strip with a thermoplastic matrix is placed on the at least one polar-cap region and wound as a circumferential winding with a continuous axial offset, wherein the lateral expansion B of the fiber strip extends along the winding axis of the shaping tool and the energy of a heat source is coupled in between the supplied fiber strip and a respective placement zone of the fibre strip so that at least the fiber strip to be placed and the already-placed fiber strip are consolidated in the placement zone.

### TECHNICAL FIELD

The present disclosure relates to a method for producing a polar-cap reinforcement for a pressure vessel, in particular a fiber-reinforced pressure vessel. The present disclosure furthermore relates to a pressure vessel having at least one such polar-cap reinforcement comprising circumferential windings and to a pressure vessel having at least one polar cap formed from the polar-cap reinforcement produced in this way.

### BACKGROUND

Pressure vessels are playing an important part in the energy transition because gases such as natural gas or hydrogen gas must initially be stored for the various applications. In many cases in this context, it is advantageous to store the gases under high pressure because it is thereby possible to store a relatively large quantity of gas in a relatively small volume. This is the case, for example, for hydrogen propulsion of buses, trucks, passenger cars or aircraft.

In order to keep the weight as low as possible for these mobile applications, use is preferably made of type-4 pressure vessels, in particular fiber-reinforced plastic liners, wherein a carbon fiber reinforcement is preferably employed. However, the high demand for lightweight pressure vessels, which can preferably be produced in large numbers from fiber composite materials, can lead to the situation where insufficient raw material (carbon fibers) is available. For this reason alone, it is expedient to keep the use of fiber reinforcement as low as possible to ensure that the consumption of material for the gas volume stored is as low as possible. Moreover, the vessels should be as light as possible, and production costs should be kept low, and this is another incentive to minimize the consumption of material in the fiber reinforcement.

Type-4 fiber-reinforced pressure vessels usually comprise a cylindrical central part, which is adjoined at both ends by a curved polar cap that closes the pressure vessel. To seal the pressure vessel, an internal plastic liner is used, said liner having the corresponding shape (a cylinder and polar caps at both ends) and being reinforced by an outer layer consisting of fiber composite material. One frequently used method for reinforcing the plastic liner is the filament winding method, in which high-strength fibers are impregnated with a matrix and wound onto the rotating plastic liner.

Here, the dimensioning of the fiber reinforcement can be roughly divided into two regions, namely into the reinforcement of the cylindrical part of the pressure vessel and the reinforcement of the curved polar caps. In the cylindrical region of the vessel, the radial forces are twice as great as the axial forces (boiler formula), i.e. approximately twice as many fibers must be wound in the radial direction as in the axial direction. Because of its three-dimensional contour, the polar-cap region is significantly more difficult to dimension because it is only with difficulty that a circumferential winding can be wound there, and it is not possible at least directly and at an industrial scale, namely at high speed and with a high throughput.

The reason is that, in conventional winding methods, the fibers do not adhere to and stay on the sloping surface of a polar cap; on the contrary, they slide down the polar cap and thus make polar-cap reinforcement in accordance with the design impossible. Here, the conventional methods are still that of producing the required radial reinforcement of the fiber reinforcement by a large number of steep helical windings (cross-windings at a certain angle to the winding axis). In this case, many more windings, having many different winding angles, are required than would actually be necessary for a pure radial reinforcement at 90°. This has the effect that a large number of axial fiber plies are also located in the cylindrical part of the pressure vessel, although they are actually used only in the polar-cap region.

Since fiber consumption and the associated production costs are very high, especially in the case of long vessels, it is desirable to reduce fiber consumption. This is possible, for example, if it is possible to use the polar-cap reinforcement and the fibers required for this purpose only in the polar-cap region of a liner. For example, the known techniques allow targeted polar-cap reinforcement.

It is obvious here to decouple this production step—reinforcement of the polar caps in the circumferential direction—from the overall winding process and to carry it out separately in order then to feed the prepared plastic liner together with the polar-cap reinforcements to the final winding process. For this purpose, structures on which fibers that are to be wound are retained so that they do not slide off are provided on a liner, for example. By appropriate shaping and arrangement of such retaining structures, it is possible to wind the polar caps before the cylindrical region of a pressure vessel. JP 2010-236614 A, for example, discloses a method for producing a composite pressure vessel on which retaining structures in the form of circumferential grooves or individual knobs are formed on the polar caps of a liner. By means of these retaining structures, the polar caps are wound first, followed by the cylindrical region of the liner. The method is completed by means of a wound layer which covers both the polar caps and the cylindrical region.

By way of example, the patent DE 10 2018 110 049 B4 also discloses a method for producing a polar-cap reinforcement in the polar-cap region of a pressure vessel, in which a retention device comprising a plurality of projecting retention elements is mounted in the region of an end section of the cylindrical central region of a liner. A polar-cap reinforcement is then produced by winding fiber material around at least part of the polar-cap region and the end section with the retention device, wherein the fiber material is guided with a direction reversal around the projecting retention elements of the retention device.

Moreover, special winding devices which are intended to produce exclusively circumferential windings in the polar-cap region of a liner are known. For example, the patent DE 10 2015 007 047 B4 discloses a method in which the outer surface of a polar cap is defined by a plurality of shaping parts. These shaping parts are arranged successively outward, starting from a winding axis of the winding body, on the winding axis, and a gap between the winding mandrel and the respective previously arranged shaping part is filled with circumferential windings. The shaping parts are then removed.

### SUMMARY

Proceeding from the above, it is the object of the present disclosure to provide an alternative method for producing a polar-cap reinforcement of a pressure vessel by means of which the quantity of reinforcing fibers for production is reduced, wherein, in particular, the fiber orientation runs in the circumferential direction. It should advantageously also be possible to use the polar-cap reinforcement itself as a polar cap without an inner liner.

It should be noted that the features presented individually in the claims may be combined in any technically feasible manner and indicate further refinements of the disclosed embodiments. The description additionally characterizes and specifies the disclosed embodiments particularly in conjunction with the figures.

The method according to the present disclosure is used to produce a polar-cap reinforcement for a pressure vessel, in particular a fiber-reinforced pressure vessel. In this context, a pressure vessel must be reinforced in a suitable manner axially and radially if an inner vessel/liner performs only the sealing function and represents the winding core for a winding process. The axial reinforcement of a wound type-4 pressure vessel runs from one pole to the other and generally also surrounds the “boss connection” at both ends, ensuring that said boss is firmly bound. Here, the typical winding angles are 5-15° because there is not yet any significant drop in the strength of the laminate relative to a 0° laminate at these angles. In the cylindrical part of the liner, radial reinforcement by means of the standard winding methods is possible.

However, a fiber structure denoted below as a polar-cap reinforcement can also be used as a polar cap itself in a pressure vessel without an inner liner. The designation “polar-cap reinforcement” therefore does not necessarily imply that some other component is being reinforced.

The method according to the disclosed embodiments for producing such a polar-cap reinforcement is distinguished by at least the following steps:
providing a shaping tool in the form of at least one curved, dome-shaped polar-cap region having a winding axis which extends along the longitudinal axis of the polar-cap region;
producing at least one polar-cap reinforcement on the shaping tool in that a preimpregnated fiber tape having a thermoplastic matrix is placed on the at least one polar-cap region and is wound onto the polar-cap region as a circumferential winding with a continuous axial offset, wherein the lateral extent B of the fiber tape extends along the winding axis of the shaping tool and the energy of a heat source is coupled in between the fiber tape supplied and a respective placement zone of the fiber tape, as a result of which, in the region of said placement zone, at least the fiber tape to be placed and already-placed fiber tape fuse and are then consolidated.

In the present disclosure, therefore, it is not a thermoset fiber composite material that is used but a preimpregnated fiber tape including a fiber composite material with a thermoplastic matrix that has a certain lateral extent, i.e. a width B. these are therefore thermoplastically preimpregnated tapes. They are flat and have a width B which is much greater than a thickness. These are typically reinforced unidirectionally.

In the production of type-4 pressure vessels, use is typically made of a thermoplastic liner including polyethylene (PE) or polyamide (PA). A fiber reinforcement is then wound onto this liner by means of a suitable fiber winding method until the resulting laminate with appropriate angles and layer thicknesses is achieved. If a thermoset matrix is used in winding, geodetic fiber placement must be chosen in most cases because otherwise the “wet” thread slips. If “towpregs” are used, which have a certain stickiness, it is possible to deviate somewhat from the geodetic path. In processing thermoset fiber composite materials, it is the case however that it is virtually impossible to produce a radial reinforcement in the polar-cap region using the direct “traditional” winding method.

The situation is different with the use according to the disclosed embodiments of thermoplastic fiber composite material. This material can be supplied in the form of fiber tape with a certain width and thickness. In this case, different fiber materials are used, e.g. carbon fibers, glass fibers or other fibers. Examples of matrixes that are used are traditional thermoplastics such as PP (polypropylene), PE (polyethylene), PA (polyamide) or even PEEK (polyether ether ketone).

These fiber tapes are wound onto spools and are dimensionally stable. They are wound on in the longitudinal direction. They are preferably very stiff along their width B, i.e. in the transverse direction, and are difficult to bend. The thermoplastic in the fiber tape can be melted; in this way, the fiber tape can be welded or joined to a thermoplastic substrate, e.g. another fiber tape or an inner vessel including the same or a similar plastic. Depending on the melting principle and technique, a very quick and targeted joint can be produced at one point, as is possible, for example, with the laser melting method.

If this material and the joining technique is applied to the production of pressure vessels, it is possible, for example, to apply a different reinforcement to a thermoplastic liner than is possible with thermoset reinforcing materials. The only restrictions are that the fiber tape must be placed straight and is virtually impossible to bend laterally. The embodiments disclosed herein therefore envisages that a fiber tape is not placed on a polar-cap region; instead a winding process in which the lateral extent B of the fiber tape extends along the winding axis is performed. The fiber tape is as it were oriented perpendicularly to the polar-cap region, with an axial offset of the fiber tape occurring with increasing diameter of the polar-cap region. Thus, fiber tape which is to be placed does not come to rest flat on the polar cap; instead, the transverse direction of the fiber tape (lateral extent B, width) is always approximately parallel to the winding axis during the winding process. In an embodiment, fiber tape to be placed can thus be fused over an extended area with fiber tape that has already been placed. To this end, in some embodiments, a firm fiber structure which includes exclusively of a circumferential winding that runs substantially in a radial direction may be formed.

By means of the thermoplastic fiber tape and the rapid melting of the matrix, the fiber tape can be fixed in such a way that a polar-cap reinforcement of the liner with a radial fiber orientation is therefore possible. Because of the likewise rapid cooling and associated fixing, slipping of the fiber tape can be prevented.

The method according to the disclosed embodiments thereby entails the advantage that it is possible by this means to produce a polar-cap reinforcement or even a polar cap itself with purely circumferential windings. This reduces the fiber needed for the overall pressure vessel since unnecessary windings in the cylindrical region can thereby be avoided. In the method according to the disclosed embodiments, at least one curved polar-cap region is wound radially, but a circumferential winding produced in this way can also extend beyond a curved polar-cap region into an adjoining cylindrical region if the shaping tool used is correspondingly designed with a cylindrical region. This is the case, for example, with an inner liner. Part of a hollow cylinder is thereby already produced together with a polar cap from the circumferential windings.

Consequently, it is possible in the winding process for the energy from a heat source to be continuously coupled in between the fiber tape supplied and a respective placement zone of the fiber tape, as a result of which, in the region of said placement zone, at least the fiber tape to be placed and already-placed fiber tape fuse and are then consolidated. The heat source used is, in particular, a laser, in particular a laser, the laser beam of which is distributed over an extended area in the region of the placement zone of the fiber tape by means of an optical system. The laser power is readily adjustable, and the positioning of a melting region, e.g. a focal spot, is likewise easy to carry out with a laser. The readily adjustable laser power and the positioning of the focal spot likewise make it possible, for example, for the fiber tape supplied to be fused not only with the previously placed fiber tape but also with a thermoplastic liner. A firm joint between the fiber reinforcement and the liner is thereby possible.

Provision is preferably made for the fiber tape to be wound on from the smaller diameter to the larger diameter of the curved polar-cap region. In this way, a winding with a progressively larger diameter can be placed continuously with an axial offset on a winding with a respectively smaller diameter. It is furthermore advantageously possible to provide for the shaping tool to rotate about its winding axis during this process, while the fiber tape is wound onto the curved polar-cap region from a fixed spool. In an alternative embodiment, it is admittedly possible to reverse the directions of movement, such that the shaping tool is fixed while a spool of fiber tape rotates about the winding axis. However, the first embodiment is preferable.

The fiber reinforcement is wound on substantially radially. Here, the fiber placement follows the contour of the shaping tool, i.e. the dome shape of the curved polar-cap region, whereby the circumferential winding is carried out with a continuous axial off-set. As the diameter D of the polar-cap region increases, however, the radial fiber reinforcement may become increasingly smaller or thinner because, with a constant fiber tape width B, the axial offset per revolution becomes larger and larger, and the layer thickness, e.g. in the radial direction, becomes smaller. This can be compensated for by using a wider fiber tape toward the outside. The process can be stopped at any time and restarted with a new tape (in this case with fiber width variation).

In one embodiment, it is therefore envisaged that the lateral extent B of the fiber tape increases from the smaller diameter to the larger diameter of the curved polar-cap region. In particular, the winding process is interrupted at least once, wherein, during this interruption, a first fiber tape is replaced by a second fiber tape with a larger lateral extent B. Alternatively, provision can be made to start with a sufficiently wide fiber tape already in the region of the smaller diameter, and this then also produces a desired minimum wall thickness in the radial direction in the region of a larger diameter.

The winding process is started in the region of the winding cylinder which is located centrally on the curved polar-cap region. This is, for example, a connection flange, a simple boss connection or a metal cylinder. The fiber tape is placed and fixed on this winding cylinder at the beginning of the winding process. Provision is furthermore preferably made for at least the placed fiber tape to be consolidated under pressure, in particular by means of a pressure roller.

Furthermore, the method can be used to produce a polar-cap reinforcement in at least two ways. In a first version, a type-4 pressure vessel is produced by providing a liner (inner vessel) with an outer fiber reinforcement, wherein the method according to the disclosed embodiments are used to reinforce the two opposite polar-cap regions. In this embodiment, the shaping tool used is therefore an inner vessel of a pressure vessel to be produced, said inner vessel being formed by a thermoplastic material and having a cylindrical central region and two curved polar-cap regions, which close the openings of the cylindrical central region. The polar-cap reinforcement according to the disclosed embodiments are then carried out on both sides of the liner, either in succession or simultaneously with a second placement head. The cylindrical part of the liner is then reinforced until a smooth surface for the polar-cap reinforcements is obtained. The axial reinforcement of the liner is then applied in accordance with the pressure vessel design, either likewise with thermoplastic fiber reinforcement or with thermoset fiber reinforcement.

The disclosed embodiments thus allow reinforcement of a liner-preferably a thermoplastic liner-in the polar-cap region by purely radial fiber plies in a separate process. The liner which is then supplied with two polar-cap reinforcements is fed to the actual winding process and can then be provided with the radial windings in the cylindrical part and with the necessary axial windings (and optionally compressing radial windings if thermoset windings are used).

In this case, the disclosed embodiments consequently also includes a pressure vessel having an inner vessel and an outer layer of reinforcing fibers wound onto the inner vessel, wherein the inner vessel has a cylindrical central region and two curved polar-cap regions, which close the openings of the cylindrical central region. The outer layer of reinforcing fibers has, in at least one curved polar-cap region of the inner vessel, a polar-cap reinforcement comprising circumferential windings which is produced by a method according to one embodiment of the disclosed embodiments.

However, the method steps described can also be carried out in such a way that a type-5 pressure vessel can be produced. The type-5 pressure vessel is a fiber-reinforced pressure vessel without a liner. If the polar-cap reinforcement is produced in such a way that the fiber reinforcement does not bond to the shaping tool, the reinforcement can be removed again from the contour of the shaping tool after the winding process. The shaping tool with the contour of a liner then no longer has to include thermoplastic material but can, for example, be formed from metal or the like, ensuring that the fiber tape does not bond to the shaping tool.

If a hollow-cylindrical tube element is likewise produced from the same composite material in addition, the three elements (two fiber-reinforced polar caps and a fiber-reinforced cylindrical tube) can then be joined together, e.g. by a welding method. It is then possible to dispense with an inner liner.

The outcome is that the inner contour of the pressure vessel is obtained without an inner liner. A component produced in this way can also be used as a shaping tool for further fiber reinforcements. Alternatively, a curved polar-cap region could be wound radially into the cylindrical region of a shaping tool, thereby giving a curved polar-cap reinforcement with an adjoining hollow-cylindrical region. For example, approximately half the cylinder length of a pressure vessel to be produced could already be formed in a polar-cap region in this way. Two components produced in this way are then joined together, e.g. welded, via their hollow cylinder and thus likewise form a cylindrical vessel with two ends curved in a dome shape.

The present disclosure therefore also comprises an embodiment in which a shaping tool is a separate component, from which the polar-cap reinforcement is removed after the production thereof. The present disclosure thus also includes a pressure vessel having a cylindrical central region and two curved polar-cap regions, which close the openings of the cylindrical central region, wherein at least one polar-cap reinforcement comprising circumferential windings, which has been produced by a method according to one embodiment of the disclosed embodiments, forms a curved polar-cap region. In particular, it is then possible for two polar-cap regions and a cylindrical central region to be joined together, in particular welded, to one another to form a vessel without an inner liner.

### BRIEF DESCRIPTION OF THE DRAWINGS

Further advantages, special features and expedient further developments of the various disclosed embodiments will be found in the dependent claims and the following description of preferred exemplary embodiments with reference to the figures.

Of the figures:

FIG. 1 shows a pressure vessel;

FIG. 2 shows a schematic longitudinal section through a pressure vessel according to FIG. 1;

FIG. 3 shows an enlarged view of a polar-cap region with radial reinforcement;

FIG. 4 shows a schematic view of a polar-cap region with radial polar-cap reinforcement according to an embodiment;

FIG. 5 shows a schematic front view of a polar-cap region at the start of a winding process in the circumferential direction;

FIG. 6 shows a schematic front view of a polar-cap region during a winding process in the circumferential direction;

FIG. 7 shows a three-dimensional view of a polar-cap region during a winding process in the circumferential direction;

FIG. 8 shows an enlarged view of a melting zone; and

FIG. 9 shows a schematic illustration of an example embodiment.

### DETAILED DESCRIPTION

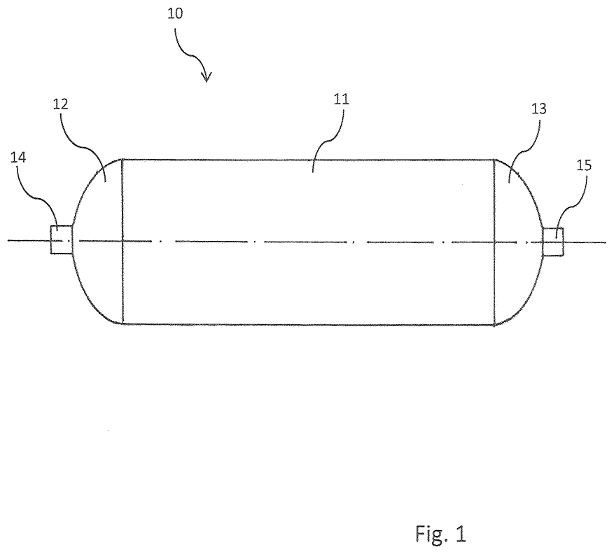

One possible pressure vessel or composite pressure vessel that can be produced with the method according to the disclosed embodiments for polar-cap reinforcement is illustrated by way of example in FIG. 1. The pressure vessel 10 has a cylindrical central part 11 and two curved polar caps 12 and 13, which close the openings of the cylindrical central region 11. Projecting connection flanges 14 and 15 can be provided on these polar caps 12, 13, wherein the shape and arrangement of these connections 14, 15 should be interpreted as merely schematic and illustrative, however. Connection flanges of this kind are also referred to as boss connections. At its ends, the cylindrical central part 11 has end sections, adjoining which are curved polar caps 12, 13.

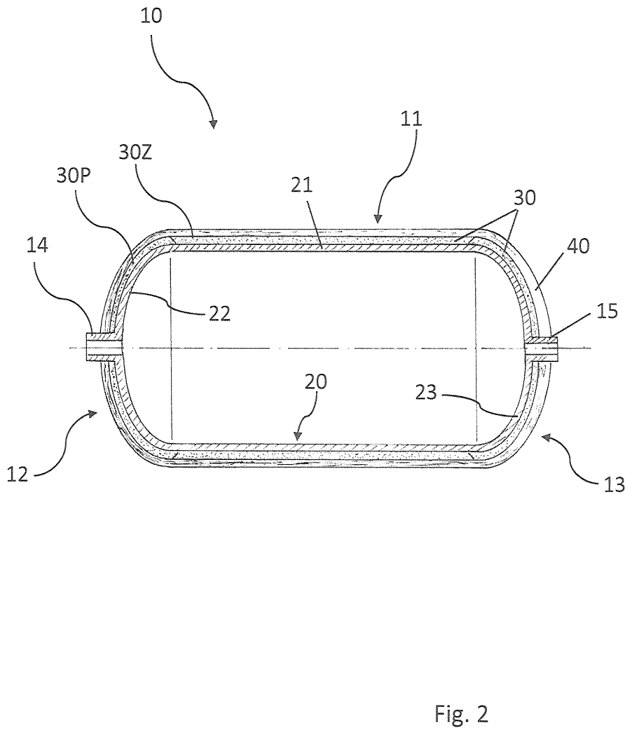

Such a pressure vessel 10 is produced, for example, by reinforcing an inner vessel with an outer layer comprising a fiber reinforcement. FIG. 2 shows this construction of the pressure vessel 10 in a schematic longitudinal section. In this case, an inner vessel 20 is wound with an outer layer including reinforcing fibers, which comprises radial and axial reinforcements. The shape of the inner vessel 20 corresponds substantially to the shape of the pressure vessel 10 to be produced, and therefore the inner vessel 20 has a cylindrical central region 21 and two curved polar-cap regions 22 and 23, which close the openings of the cylindrical central region 21. The inner vessel 20 is preferably formed by a plastic liner, the shape of which is produced in an extrusion blow-molding method, for example. In particular, the inner vessel 20 is a liner including thermoplastic material, e.g. PE or PA. An inner vessel 20 of this kind is wound with reinforcing fibers at various angles and along various paths.

FIG. 2 shows a fiber reinforcement of a plastic liner 20, showing how this can be embodied in an advantageous manner. This provides a radial reinforcement 30 on the entire liner 20, wherein this comprises the cylindrical central region 21 and the two polar-cap regions 22 and 23. An axial reinforcement 40 is furthermore provided over the entire vessel 10. By virtue of this ideal fiber alignment in the direction of force, it is possible to exploit the maximum laminate and fiber properties.

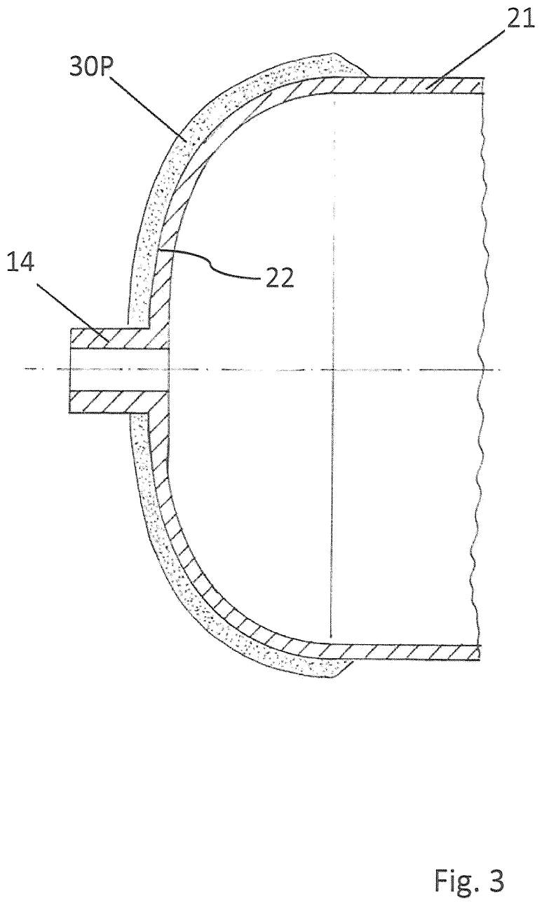

Since such a radial reinforcement 30 cannot readily be wound in continuous form on a curved polar-cap region, this radial reinforcement 30 is divided into a cylindrical reinforcement 30Z and two polar-cap reinforcements 30P. The cylindrical reinforcement 30Z is located in the cylindrical region of the pressure vessel 10, while each polar cap has a polar-cap reinforcement, wherein only a left-hand polar-cap reinforcement is provided by way of example with the reference numeral 30P in FIG. 2. FIG. 3 shows the left-hand polar-cap region 22 of a liner once again on an enlarged scale. The radial reinforcement 30P covers the region of the boss connection 14 as far as the cylindrical central region 21 of the liner and optionally projects into the cylindrical central region 21, as indicated in the embodiment in FIG. 3. The two polar-cap reinforcements 30P are produced before the cylindrical reinforcement 30Z and before the axial reinforcement 40 is applied, for example. The production and use of a polar-cap reinforcement 30P is described below.

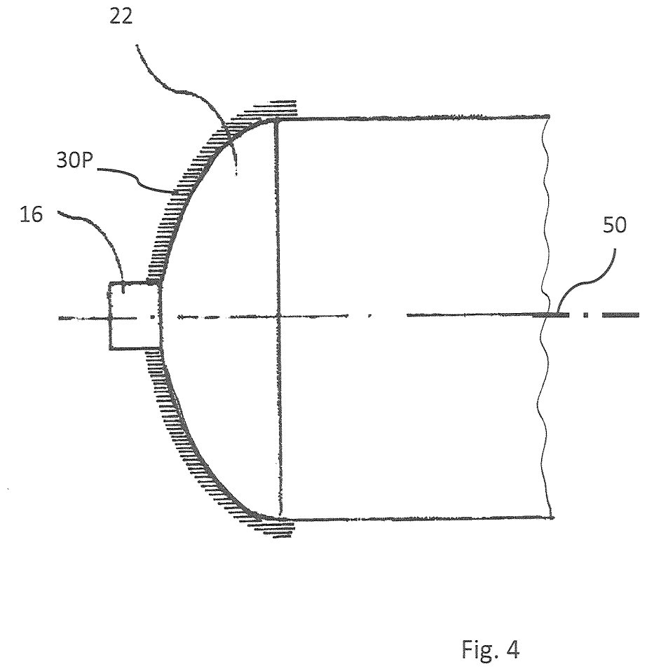

In the first instance, FIG. 4 shows a schematic view of a polar-cap region with radial polar-cap reinforcement according to an embodiment. From the figure, it can be seen that the polar-cap reinforcement 30P extends over the curved polar-cap region 22, starting from a winding cylinder 16. The winding cylinder 16 can be, for example, a connection flange, a boss connection or a metal cylinder (non-boss side). It can also be seen from the figure that the polar-cap reinforcement 30P includes a plurality of circumferential plies of a fiber tape with a certain lateral extent, wherein the lateral extent extends along the winding axis 50, which corresponds to the longitudinal axis of the polar-cap region 22.

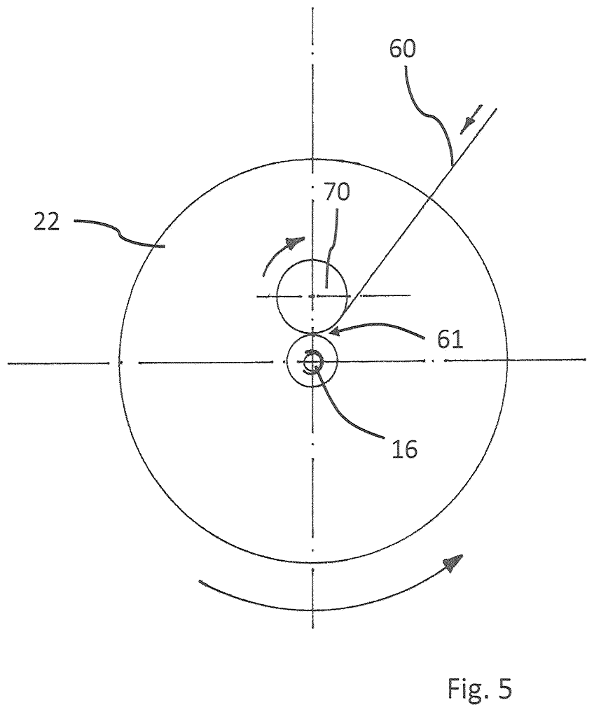

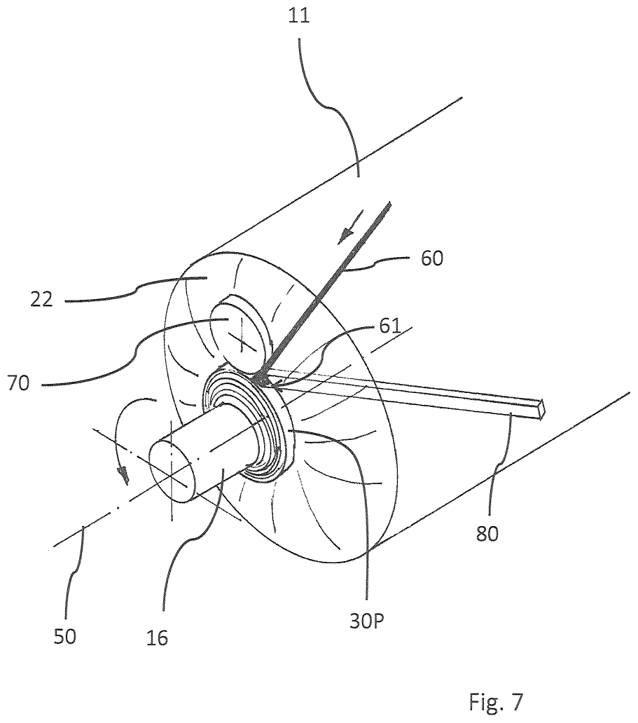

FIG. 5 shows a schematic front view of a polar-cap region at the start of a winding process in the circumferential direction. The shaping tool in the form of the polar-cap region 22 rotates about its winding axis while a fiber tape 60 is being wound up radially. During this process, the fiber tape 60 is first of all placed on the winding cylinder 16 and fixed. A substantially radial circumferential winding comprising fiber tape 60 is then wound onto the polar-cap region 22 with a continuous axial offset. In order to fix the fiber tape 60 during this process, the energy of a heat source is coupled in in the placement zone 61. This is accomplished by means of a laser, for example (see FIG. 7). A fiber tape to be placed is thereby fused at least with an already placed fiber tape situated underneath and is then consolidated. This consolidation preferably takes place under pressure, wherein a pressure roller 70 is provided for this purpose, for example, in the embodiment of FIG. 5.

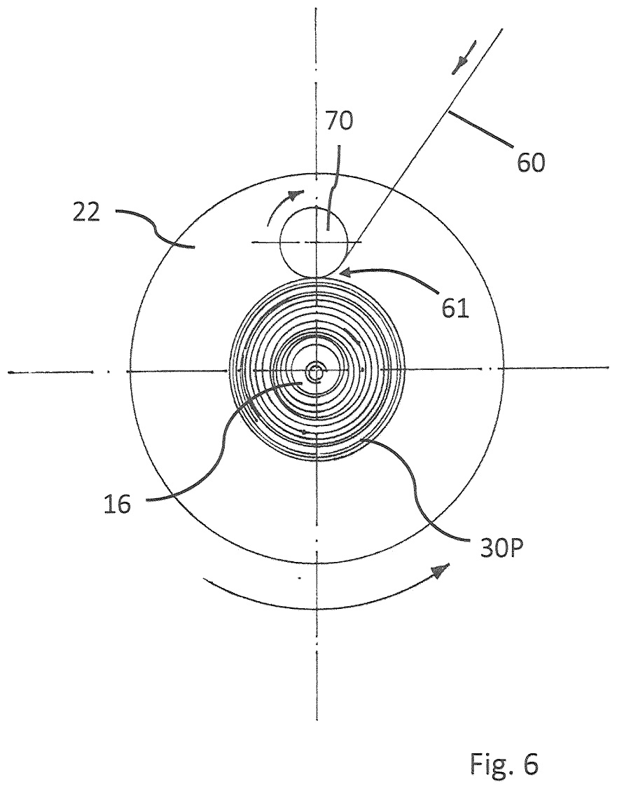

FIG. 6 shows a schematic front view of a polar-cap region during a winding process in the circumferential direction, wherein the winding has progressed further than in FIG. 5. It can be seen how the polar-cap reinforcement 30P is formed on the polar-cap region 22. FIG. 7 likewise shows an advanced state during the winding process. This three-dimensional view also shows schematically the coupling in of the energy of a laser beam 80 in a placement zone 61. It can furthermore be seen that the fiber tape 60 is wound on as a strip in such a way that its lateral extent runs along the winding axis. This ensures that the fiber tape 60 is not bent laterally during the winding process but can be applied continuously with an axial offset to the polar-cap region 22. In this case, a fiber tape 60 to be applied is always fused with an already applied fiber tape, resulting in the formation of a firm fiber structure. Also shown is the pressure roller 70 which presses the fiber tape 60 on over an extended area.

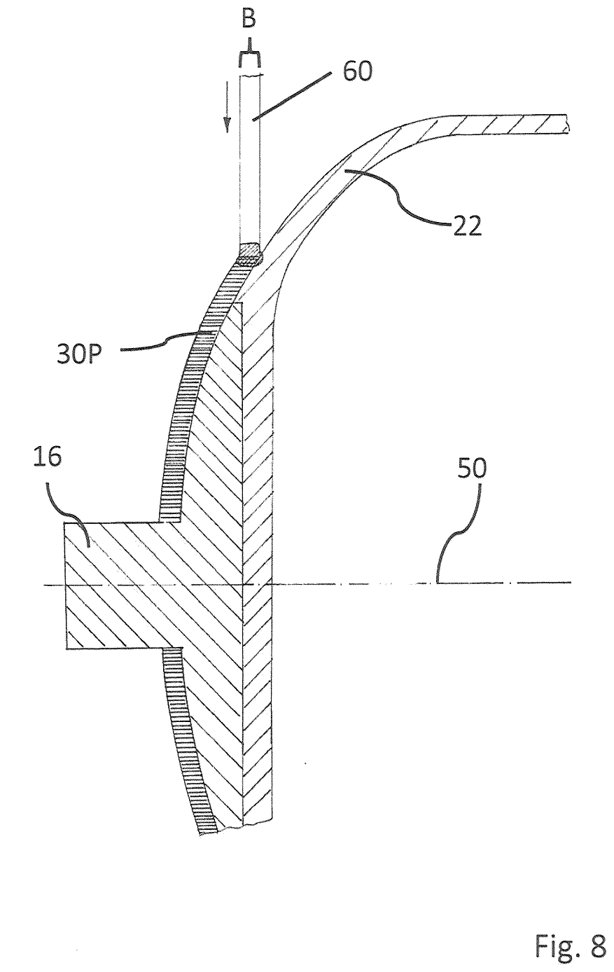

The alignment of the fiber tape 60 can also be seen from FIG. 8, which shows a somewhat enlarged view of a melting zone. The fiber tape 60 to be applied has a lateral extent B which extends along the winding axis 50. The winding process can be described overall as follows: a shaping tool or thermoplastic liner is clamped on an axis of rotation, for example, and the rotation of the liner takes place about the longitudinal axis 50. The fiber tape is wound on from the small to the large diameter. The thermoplastic fiber tape 60 is fixed on the cylindrical part of the boss connection or on a metal stud. The liner rotates, and the thermoplastic fiber tape is wound on. A laser beam is coupled into the contact plane between the fiber tape supplied and the point of application, i.e. in a placement zone. An optical system distributes the laser beam over an extended area of the fiber tape supplied and of the placement zone, giving rise to a temperature of the surfaces above the melting point of the thermoplastic matrix in the contact location. A pressure roller 70 presses the melted fiber tape 60 onto the likewise melted placement point and consolidates the material.

Behind the placement location, the material cools again quickly because the amount of energy introduced is only sufficient to ensure that the material becomes molten at the placement point and can be joined. The fiber tape 60 supplied is thus firmly joined and fixed within a very short time. Slipping is thus prevented.

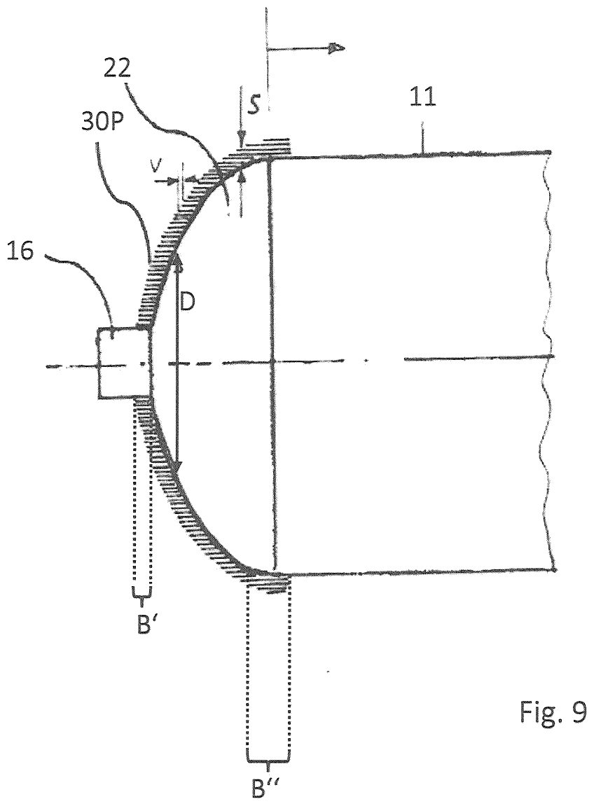

The fiber reinforcement is thus wound on radially, wherein the fiber placement follows the contour of the polar-cap region. In this regard, FIG. 9 shows a schematic illustration of an example embodiment. As the diameter D increases, the radial fiber reinforcement 30P becomes increasingly thinner because, with a constant fiber tape width, the axial offset V per revolution becomes larger and larger, and the layer thickness s in the radial direction becomes smaller. This can be compensated for by using a wider fiber tape toward the outside. The process can be stopped at any time and restarted with a new tape (in this case with fiber width variation), for example.

FIG. 9 therefore shows an embodiment in which the width B″ in the outer region is greater at a larger diameter D than the width B′ in the inner region at a smaller diameter D. This is the case especially in the transitional region from the polar-cap region 22 to the cylindrical central part 11.

The winding process is continued until the cylindrical central part 11 of the liner has been reached. The polar-cap reinforcement is carried out on both sides of the liner, either in succession or simultaneously with a second placement head. The cylindrical part of the liner is then reinforced until a smooth surface for the polar-cap reinforcements is obtained. The axial reinforcement of the liner is then applied in accordance with the pressure vessel design, either likewise with thermoplastic fiber reinforcement or with thermoset fiber reinforcement.

With appropriate design, however, the polar-cap reinforcement 30P described can also itself form a respective polar cap on a type-5 pressure vessel, with no inner vessel (liner) being used. The polar-cap reinforcement 30P is then removed again from the shaping tool after its production. What is claimed is:

1. A method for producing a polar-cap reinforcement for a fiber-reinforced pressure vessel,
characterized by the following steps:
providing a shaping tool in the form of at least one curved, dome-shaped polar-cap region having a winding axis which extends along the longitudinal axis of the polar-cap region; and
producing at least one polar-cap reinforcement on the shaping tool in that a preimpregnated fiber tape having a thermoplastic matrix is placed on the at least one polar-cap region and, wherein the preimpregnated fiber tape is wound onto the at least one polar-cap region as a circumferential winding with a continuous axial offset, wherein a lateral extent B of the preimpregnated fiber tape extends along the winding axis of the shaping tool and an energy of a heat source is coupled in between the preimpregnated fiber tape supplied and a respective placement zone of the preimpregnated fiber tape, as a result of which, in the region of said placement zone, at least the fiber tape to be placed and already-placed fiber tape fuse and are then consolidated.

2. The method as claimed in claim 1,
characterized in that the heat source is a laser, in particular a laser, the laser beam of which is distributed over an extended area in the region of the placement zone by means of an optical system.

3. The method as claimed in claim 1, characterized in that the fiber tape is wound on from a smaller diameter to a larger diameter of the curved polar-cap region.

4. The method as claimed in claim 3, characterized in that the lateral extent B of the fiber tape increases from the smaller diameter to the larger diameter of the curved polar-cap region.

5. The method as claimed in claim 4,
characterized in that the fiber tape winding process is interrupted at least once, wherein, during this interruption, a first fiber tape is replaced by a second fiber tape with a larger lateral extent B.

6. The method as claimed in claim 1, characterized in that the at least one curved polar-cap region of the shaping tool has a central winding cylinder, on which the fiber tape is placed and fixed at the beginning of the fiber tape winding process.

7. The method as claimed in claim 1, characterized in that
the shaping tool is an inner vessel of a pressure vessel to be produced, said inner vessel being is formed by a thermoplastic material and having has a cylindrical central region and two curved polar-cap regions, which close the openings of the cylindrical central region, wherein the polar-cap reinforcement is produced on both polar-cap regions.

8. The method as claimed in claim 1, characterized in that
the shaping tool is a separate component, from which the polar-cap reinforcement (30P) is removed after the production thereof.

9. The method as claimed in claim 1, characterized in that
a produced circumferential winding extends the curved polar-cap region into an adjoining cylindrical region of the shaping tool.

10. A pressure vessel having an inner vessel and an outer layer of reinforcing fibers wound onto the inner vessel, wherein the inner vessel has a cylindrical central region and two curved polar-cap regions, which close openings of the cylindrical central region,
characterized in that the outer layer of reinforcing fibers comprises polar-cap reinforcement comprising circumferential windings in at least one curved polar-cap region of the inner vessel, wherein producing the polar-cap reinforcement comprises:
providing a shaping tool in the form of at least one curved, dome-shaped polar-cap region having a winding axis which extends along the longitudinal axis of the polar-cap region; and
producing at least one polar-cap reinforcement on the shaping tool in that a preimpregnated fiber tape having a thermoplastic matrix is placed on the at least one polar-cap region and, wherein the preimpregnated fiber tape is wound onto the at least one polar-cap region as a circumferential winding with a continuous axial offset, wherein a lateral extent B of the preimpregnated fiber tape extends along the winding axis of the shaping tool and an energy of a heat source is coupled in between the preimpregnated fiber tape supplied and a respective placement zone of the preimpregnated fiber tape, as a result of which, in the region of said placement zone, at least the fiber tape to be placed and already-placed fiber tape fuse and are then consolidated.

11. A pressure vessel having a cylindrical central region and two curved polar-cap regions, which close openings of the cylindrical central region,
characterized in that the at least one polar-cap reinforcement comprises circumferential windings and forms a curved polar-cap region of the pressure vessel, wherein producing the polar-cap reinforcement comprises:
providing a shaping tool in the form of at least one curved, dome-shaped polar-cap region having a winding axis which extends along the longitudinal axis of the polar-cap region; and
producing at least one polar-cap reinforcement on the shaping tool in that a preimpregnated fiber tape having a thermoplastic matrix is placed on the at least one polar-cap region and, wherein the preimpregnated fiber tape is wound onto the at least one polar-cap region as a circumferential winding with a continuous axial offset, wherein a lateral extent B of the preimpregnated fiber tape extends along the winding axis of the shaping tool and an energy of a heat source is coupled in between the preimpregnated fiber tape supplied and a respective placement zone of the preimpregnated fiber tape, as a result of which, in the region of said placement zone, at least the fiber tape to be placed and already-placed fiber tape fuse and are then consolidated.

12. The pressure vessel as claimed in claim 11, characterized in that the two curved polar-cap regions and the cylindrical central region are joined together to form a vessel without an inner liner.

13. The pressure vessel as claimed in claim 12, wherein the two curved polar-cap regions and the cylindrical central region are welded together.

14. The pressure vessel as claimed in claim 10, wherein a produced circumferential winding extends beyond the curved polar-cap region into an adjoining cylindrical region of the shaping tool.

15. The pressure vessel as claimed in claim 11, wherein a produced circumferential winding extends beyond the curved polar-cap region into an adjoining cylindrical region of the shaping tool.

16. The method as claimed in claim 1, further comprising:
welding the wound preimpregnated fiber tape on the shaping tool and already-placed fiber tape.

17. The pressure vessel as claimed in claim 10, wherein the polar-cap reinforcement is welded to the inner vessel.

18. The pressure vessel as claims in claim 17, wherein the inner vessel is a thermoplastic substrate.

19. The pressure vessel as claimed in claim 11, wherein the polar-cap reinforcement is welded to the inner vessel.

20. The pressure vessel as claims in claim 19, wherein the inner vessel is a thermoplastic substrate.
